(19) United States
(12) Patent Application Publication
(10) Pub. No.: US 2024/0396623 A1
(43) Pub. Date: Nov. 28, 2024

(54) WIRELESS RELAY SYSTEM, WIRELESS RELAY METHOD, SOFTWARE DEFINED RADIO DEVICE

(71) Applicant: NIPPON TELEGRAPH AND TELEPHONE CORPORATION, Tokyo (JP)

(72) Inventors: Yu ONO, Musashino-shi, Tokyo (JP); Tatsuya NAKATANI, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/691,895

(22) PCT Filed: Sep. 15, 2021
(86) PCT No.: PCT/JP2021/033971

§ 371 Date: Mar. 14, 2024

(51) Int. Cl. H04B 7/185

(52) U.S. Cl. CPC H04B 7/18513

(57) ABSTRACT

A radio relay system includes a first software radio device that performs radio communication with a first radio device and a second software radio device that performs radio communication with a second radio device. The first software radio device captures a radio signal received from the first radio device as iq data, transfers the captured iq data to the second software radio device in real time, converts the iq data transferred from the second software radio device into a radio signal, and transmits the radio signal to the first radio device. The second software radio device captures a radio signal received from the second radio device as iq data, transfers the captured iq data to the first software radio device in real time, converts the iq data transferred from the first software radio device into a radio signal, and transmits the radio signal to the second radio device.

### TECHNICAL FIELD

The present invention relates to a radio relay system, a radio relay method, and a software radio device utilizing a software radio technology.

### BACKGROUND ART

Patent Literature 1 proposes a method in which a relay device having only an antenna and a transmission and reception function connects radio terminals under its own control, and signal processing is performed by an upper server.

### CITATION LIST

### Patent Literature

Patent Literature 1: JP 2018-42135 A

### SUMMARY OF INVENTION

### Technical Problem

In the technique according to Patent Literature 1, it is necessary to newly prepare a transceiver compatible with a frequency and a radio standard every time a type of a radio terminal connected to a relay device is changed; however, it is difficult to flexibly cope with this.

The present invention has been made in view of the above-described problems. An object of the present invention is to implement relay between a wide variety of radio devices.

### Solution to Problem

A radio relay system according to an aspect of the present invention is a radio relay system that relays radio communication between a first radio device and a second radio device. The radio relay system includes a first software radio function unit configured to perform radio communication with a first radio device and a second software radio function unit configured to perform radio communication with a second radio device. The first software radio function unit captures a radio signal received from the first radio device as iq data, transfers the captured iq data to the second software radio function unit in real time, converts the iq data transferred from the second software radio function unit into a radio signal, and transmits the radio signal to the first radio device. The second software radio function unit captures a radio signal received from the second radio device as iq data, transfers the captured iq data to the first software radio function unit in real time, converts the iq data transferred from the first software radio function unit into a radio signal, and transmits the radio signal to the second radio device.

A radio relay method according to an aspect of the present invention includes: a receiving step of receiving a radio signal from a radio device; a transfer step of capturing the radio signal received in the receiving step as iq data and transferring the captured iq data outside in real time; and a transmission step of converting the iq data transferred from the outside into a radio signal and transmitting the radio signal to the radio device.

A software radio device according to an aspect of the present invention is a software radio device that relays radio communication between a first radio device and a second radio device. The software radio device includes a first software radio function unit configured to perform radio communication with the first radio device and a second software radio function unit configured to perform radio communication with the second radio device. The first software radio function unit captures a radio signal received from the first radio device as iq data, transfers the captured iq data to the second software radio function unit in real time, converts the iq data transferred from the second software radio function unit into a radio signal, and transmits the radio signal to the first radio device. The second software radio function unit captures a radio signal received from the second radio device as iq data, transfers the captured iq data to the first software radio function unit in real time, converts the iq data transferred from the first software radio function unit into a radio signal, and transmits the radio signal to the second radio device.

A software radio device according to an aspect of the present invention includes: a transceiver configured to perform radio communication with a radio device; and a control unit configured to capture a radio signal received by the transceiver as iq data, transfer the captured iq data to the outside in real time, convert the iq data transferred from the outside into a radio signal, and transmit the radio signal to the radio device by the transceiver.

### Advantageous Effects of Invention

With the present invention, it is possible to achieve relay between various radio devices.

### BRIEF DESCRIPTION OF DRAWINGS

FIG. 1 is a diagram schematically illustrating a configuration and operation of a radio relay system according to a first embodiment.

FIG. 2 is a diagram schematically illustrating a configuration and operation of the radio relay system according to the first embodiment.

FIG. 3 is a block diagram illustrating a configuration example of a software radio device according to the first embodiment.

### DESCRIPTION OF EMBODIMENTS

Hereinafter, an embodiment will be described with reference to the accompanying drawings. In the present disclosure, redundant descriptions will be simplified or omitted as appropriate. Note that the present invention is not limited to the embodiments described below. The present invention may include various modifications and combinations of configurations disclosed by the following embodiment without departing from the spirit of the present disclosure.

### First Embodiment

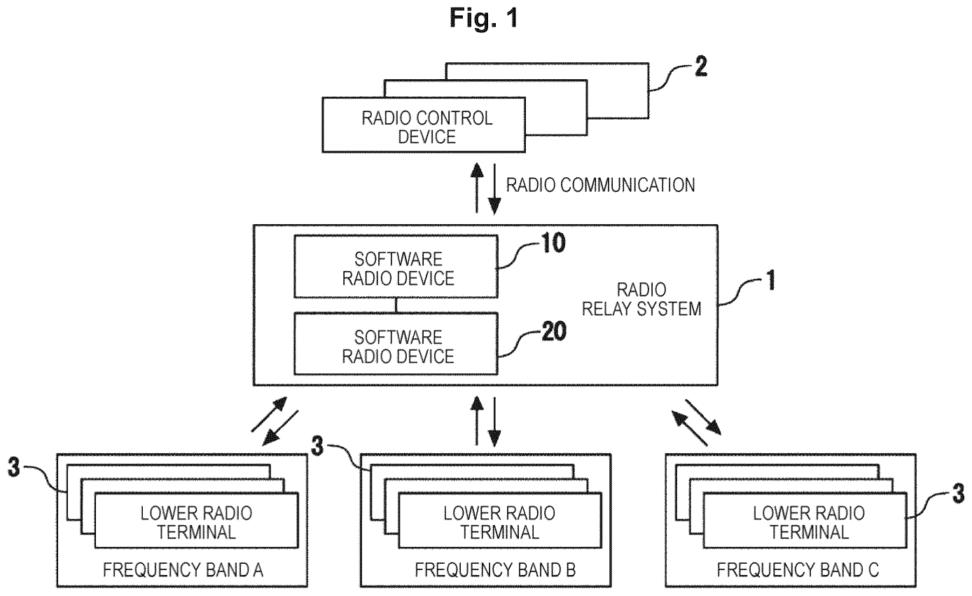

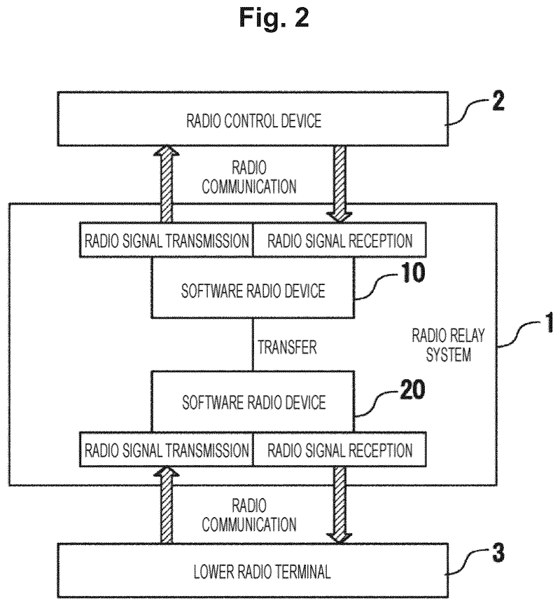

FIGS. 1 and 2 are diagrams schematically illustrating a configuration and an operation of a radio relay system 1 according to a first embodiment. The radio relay system 1 is a system that relays radio communication between a first radio device and a second radio device. The first radio device is, for example, an upper-level radio control device 2. The second radio device is, for example, a lower radio terminal 3 under the control of the radio control device 2. The radio relay system 1 can be used in various types of radio communication in a mobile communication field, an IoT field, or the like. The radio relay system 1 can also be used, for example, in a local area network or the like in a large-scale commercial facility or the like.

As illustrated in FIG. 1, a plurality of radio control devices 2 may be provided. Similarly, a plurality of lower radio terminals 3 may be provided. In addition, each of the plurality of lower radio terminals 3 may belong to different frequency bands as illustrated in FIG. 1.

The radio relay system 1 according to the present embodiment includes a first software radio device 10 and a second software radio device 20. Note that the radio relay system 1 according to the present embodiment may include at least two software radio devices. The radio relay system 1 may include three or more software radio devices. The number of software radio devices constituting the radio relay system 1 can be appropriately set according to the frequency band of the radio communication to be relayed, the required transfer speed, and the like. The software radio devices are connected by a line capable of high-speed data communication. Each software radio device is connected by, for example, a UTP cable or an optical cable. Alternatively, each software radio device may be connected by a coaxial cable or the like.

The first software radio device 10 corresponds to a first software radio function unit according to the present disclosure. The second software radio device 20 corresponds to a second software radio function unit according to the present disclosure. The first software radio function unit and the second software radio function unit may be configured as one software radio device having the same housing. That is, the first software radio device 10 and the second software radio device 20 in the present embodiment may be configured as one software radio device having the same housing. In this case, two input ports and two output ports may be provided in the same housing.

The first software radio device 10 performs radio communication with the radio control device 2, which is an example of the first radio device. The second software radio device 20 performs radio communication with the lower radio terminal 3, which is an example of the second radio device.

The first software radio device 10 captures a radio signal received from the radio control device 2 as iq data. The first software radio device 10 transfers the captured iq data to the second software radio device 20 in real time over a high-speed line.

On the other hand, the second software radio device 20 captures a radio signal received from the lower radio terminal 3 as iq data. The second software radio device 20 transfers the captured iq data to the first software radio device 10 in real time over a high-speed line.

The first software radio device 10 converts the iq data transferred from the second software radio device 20 into a radio signal and transmits the radio signal to the radio control device 2 as a radio wave. The second software radio device 20 converts the iq data transferred from the first software radio device 10 into a radio signal and transmits the radio signal to the lower radio terminal 3 as a radio wave.

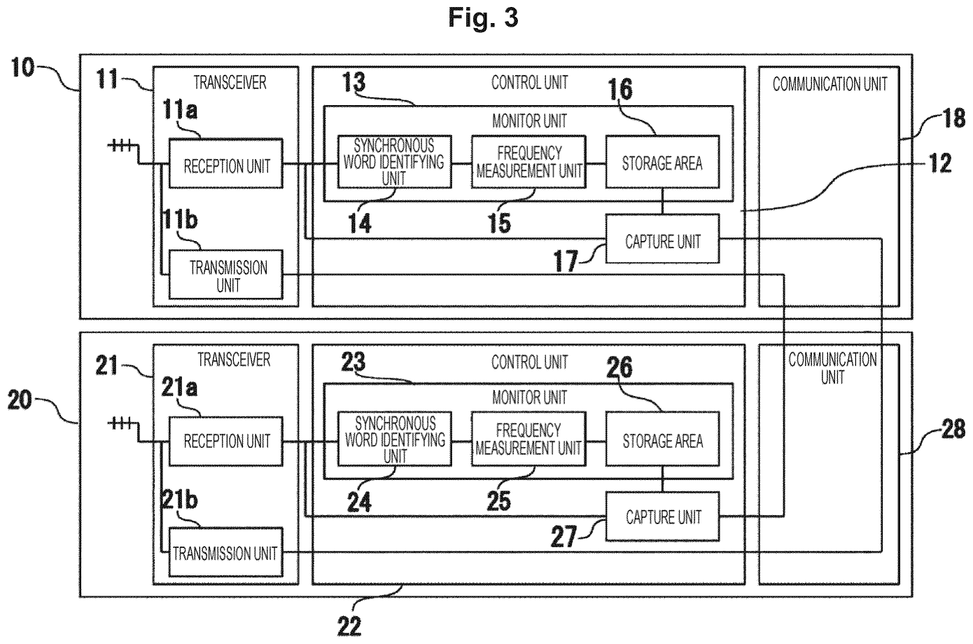

FIG. 3 is a block diagram illustrating a configuration example of a software radio device according to the first embodiment. As an example, the first software radio device 10 includes a transceiver 11 that performs radio communication with a radio device, and a control unit 12 that implements various functions of the first software radio device 10. The transceiver 11 includes a reception unit 11a that receives a signal from the radio device and a transmission unit 11b that transmits a signal to the radio device. The control unit 12 includes a monitor unit 13 that implements a radio signal monitoring function. The monitor unit 13 includes, for example, a synchronous word identifying unit 14 that identifies a synchronization word, a frequency measurement unit 15 that measures a frequency, a storage area 16, and the like. In addition, the control unit 12 includes a capture unit 17 that implements a radio signal capture function. The capture unit 17 captures the radio signal received by the transceiver 11 as iq data, and transfers the captured iq data to the outside in real time. The capture unit 17, for example, transfers iq data to the second software radio device 20 via a communication unit 18.

Similarly to the first software radio device 10, the second software radio device 20 includes a transceiver 21 that performs radio communication with a radio device, and a control unit 22 that implements various functions of the second software radio device 20. The transceiver 21 includes a reception unit 21a that receives a signal from the radio device and a transmission unit 21b that transmits a signal to the radio device. The control unit 22 includes a monitor unit 23 that implements a radio signal monitoring function. The monitor unit 23 includes, for example, a synchronous word identifying unit 24 that identifies a synchronization word, a frequency measurement unit 25 that measures a frequency, a storage area 26, and the like. In addition, the control unit 22 includes a capture unit 27 that implements a radio signal capture function. The capture unit 27 captures the radio signal received by the transceiver 21 as iq data, and transfers the captured iq data to the outside in real time. The capture unit 27, for example, transfers iq data to the first software radio device 10 via a communication unit 28.

The radio relay system 1 receives and captures a radio signal within a designated frequency band. In the present embodiment, it is possible to realize real-time capture and flexible change of the frequency band of the capture target by utilizing the characteristics of software radio.

The software radio device constituting the radio relay system 1 can identify a synchronization word in a frame constituting a radio signal transmitted from a radio device such as the radio control device 2 and the lower radio terminal 3. The frame includes a preamble, a synchronization word, a PHY header, a physical layer data payload, and an FCS. By identifying the synchronization word, the software radio device can efficiently capture only the frequency band used by the radio device that is the relay target.

With the radio relay system 1 and the software radio device constituting the radio relay system 1 configured as described above, it is possible to implement relaying between various radio devices by capturing and transferring radio signals. According to the present embodiment, the type of the radio device capable of relaying is not limited by the frequency, the radio standard, or the installation location. Further, according to the present embodiment, for example, the lower radio terminal 3 at a remote location can be accommodated in the radio control device 2. Note that each function of the radio relay system 1 and the software radio device constituting the radio relay system 1 can also be implemented as a radio relay method.

### INDUSTRIAL APPLICABILITY

The radio relay system, the radio relay method, and the software radio device according to the present invention can be used for various types of radio communication.

### REFERENCE SIGNS LIST

1 Radio relay system
2 Radio control device
3 Lower radio terminal
10 Software radio device
11 Transceiver
11a Reception unit
11b Transmission unit
12 Control unit
13 Monitor unit
14 Synchronous word identifying unit
15 Frequency measurement unit
16 Storage area
17 Capture unit
18 Communication unit
20 Software radio device
21 Transceiver
21a Reception unit
21b Transmission unit
22 Control unit
23 Monitor unit
24 Synchronous word identifying unit
25 Frequency measurement unit
26 Storage area
27 Capture unit
28 Communication unit

1. A radio relay system that relays radio communication between a first radio and a second radio, the radio relay system comprising:
first software radio function circuitry unit configured to perform radio communication with the first radio; and
second software radio function circuitry configured to perform radio communication with the second radio, wherein
the first software radio function circuitry captures a radio signal received from the first radio as iq data, transfers the captured iq data to the second software radio function circuitry in real time, converts the iq data transferred from the second software radio function circuitry into a radio signal, and transmits the radio signal to the first radio, and
the second software radio function circuitry captures a radio signal received from the second radio as iq data, transfers the captured iq data to the first software radio function circuitry in real time, converts the iq data transferred from the first software radio function circuitry into a radio signal, and transmits the radio signal to the second radio.

2. A radio relay method comprising:
receiving a radio signal from a radio;
capturing the radio signal received in the receiving as iq data and transferring the captured iq data outside in real time; and
converting iq data transferred from the outside into a radio signal and transmitting the radio signal to the radio.

3. A software radio device that relays radio communication between a first radio and a second radio, the software radio device comprising:
a first software radio function circuitry configured to perform radio communication with the first radio; and
a second software radio function circuitry configured to perform radio communication with the second radio, wherein
the first software radio function circuitry captures a radio signal received from the first radio as iq data, transfers the captured iq data to the second software radio function circuitry in real time, converts the iq data transferred from the second software radio function circuitry into a radio signal, and transmits the radio signal to the first radio, and
the second software radio function circuitry captures a radio signal received from the second radio as iq data, transfers the captured iq data to the first software radio function circuitry in real time, converts the iq data transferred from the first software radio function circuitry into a radio signal, and transmits the radio signal to the second radio.

4. (canceled)
